(19) United States
(12) Patent Application Publication
(10) Pub. No.: US 2023/0378878 A1
(43) Pub. Date: Nov. 23, 2023

(54) FLEXIBLE ISOLATED POWER-SWITCH GATE-DRIVE POWER SUPPLY

(71) Applicant: Cummins Inc., Columbus, IN (US)

(72) Inventors: Dakshina S. Murthy-Bellur, Plymouth, MN (US); Santhosh Krishnamoorthi, Indianapolis, IN (US); Yu Wei, Columbus, IN (US); Latif M. Shaikh, Pune (IN); Jaroslaw Leonarski, Columbus, IN (US); Minyu Cai, Maplewood, MN (US)

(21) Appl. No.: 18/031,094

(22) PCT Filed: Sep. 29, 2021
(86) PCT No.: PCT/US2021/052636

§ 371 Date: Apr. 10, 2023

Related U.S. Application Data
(60) Provisional application No. 63/090,491, filed on Oct. 12, 2020.

(51) Int. Cl. H02M 3/335; H02P 27/06; H02M 1/08; B60R 16/033

(52) U.S. Cl. CPC H02M 3/33569; H02P 27/06; H02M 1/08; B60R 16/033

(57) ABSTRACT

A system is provided for flexible power switch gate-drive power supply. The power supply includes a primary stage comprising an inverter and a voltage source, an isolator electrically coupled with outputs of the primary stage and configured to change voltage level, a secondary stage comprising a rectifier and electrically coupled with outputs of the isolator, and a controller electrically coupled with the primary stage and the secondary stage.

### CROSS-REFERENCE TO RELATED APPLICATION

This application claims priority to U.S. Provisional Application No. 63/090,491, filed on Oct. 12, 2020, incorporated herein by reference in its entirety.

### FIELD OF THE DISCLOSURE

The present disclosure generally relates to voltage supplies, more specifically to gate-drive circuits for a voltage-driven type power switching device.

### BACKGROUND OF THE DISCLOSURE

A power switch, such as insulated-gate bipolar transistor (IGBT) and metal-oxide-semiconductor field-effect transistor (MOSFET), requires an isolated gate-drive power supply providing gate voltages to turn on and off. The required gate voltages vary by technology and manufacturer. For example, the turn-on/off voltages may be +15/−8 volts or +15/0 volts for Si-based IGBTs and +10/0 volts for Si-based MOSFETs, while +18/−2 volts or +18/0 volts may be used for the turn-on/off voltages for SiC-based MOSFETs. If the turn-off voltage is zero, only a positive gate voltage is required for turn-on, so a unipolar power supply is sufficient. If the turn-off voltage is negative, positive and negative voltages are required for turn-on and turn-off, respectively, so a bipolar power supply is required. As such, there is a need for a more flexible power supply that may be capable of providing for more than just one type of power switch.

### SUMMARY OF THE DISCLOSURE

The present disclosure provides systems and methods for flexible power switch gate-drive power supply, the power supply including a primary stage comprising an inverter and a voltage source, an isolator electrically coupled with outputs of the primary stage and configured to change voltage level, a secondary stage comprising a rectifier and electrically coupled with outputs of the isolator, and a controller electrically coupled with the primary stage and the secondary stage. In some examples, the secondary stage is configured as a full-bridge rectifier to provide the unipolar power supply, and furthermore, a voltage divider comprising a Zener diode in series with a resistor is connected thereto.

In some examples, the isolator is a transformer comprising a tap. In some examples, a ratio of a turn-on voltage of the flexible power supply to a turn-off voltage of the flexible power supply is determined based on a turns ratio of two coils on the transformer. Furthermore, in some examples, the secondary stage is configured as a half-bridge and electrically coupled to the tap with one of the outputs of the secondary stage to provide the bipolar power supply. Also in some examples, the secondary stage is configured as a full-bridge rectifier and a voltage divider is connected to provide the bipolar power supply, the voltage divider comprising a Zener diode in series with a resistor. There may be multiple secondary stages, where each rectifier is independently configured to provide both the unipolar power supply and the bipolar power supply. The primary stage may include a push-pull inverter, a half-bridge inverter, or a full-bridge inverter. The isolator may include a transformer or an optical isolator. The secondary stage may include a half-bridge rectifier or a full-bridge rectifier.

In some examples, the controller is configured to regulate gate voltage of the power supply based on a sensed output voltage value of the secondary stage. In some examples, the gate voltage is regulated by increasing or decreasing, by the controller, a turn-on duration of switches in the inverter of the primary stage. In some examples, at least one of the primary stage or the secondary stage is modular and/or changeable. The primary stage or secondary stage may be soldered on the circuit board to maintain an electrical connection. The primary or secondary stage is electrically disconnected from the circuit board when the soldering is removed (unsoldered) from the circuit board.

Also disclosed herein are vehicles using the flexible power switch gate-drive power supply. The vehicle includes a motor, an energy storage configured to provide electrical power to the motor, and an inverter coupled with the motor and the energy storage. The inverter includes a plurality of flexible power switch gate-drive power supplies, each including a primary stage comprising an inverter and an power source, an isolator electrically coupled with outputs of the primary stage and configured to change voltage level, a secondary stage comprising a rectifier and electrically coupled with outputs of the isolator, and a controller electrically coupled with the primary stage and the secondary stage. The inverter also includes a plurality of gate drive circuits each operative coupled with one of the plurality of flexible power switch gate-drive power supplies and a plurality of power switches. The power switches are operatively coupled with the gate drive circuits and are configured to operate the inverter. The power switches are controlled by the gate drive circuits and are configured to receive electrical power provided by the gate-drive power supplies.

In some examples, at least one of the primary stage or the secondary stage is modular or changeable according to turn-on and turn-off voltage value requirements of the power switch. In some examples, the primary stage comprises a push-pull inverter, a half-bridge inverter, or a full-bridge inverter. In some examples, the isolator is a transformer comprising a tap, and the secondary stage is configured as a half-bridge rectifier and electrically coupled to the tap with one of the outputs of the secondary stage to provide a bipolar power supply for the electronic device. In some examples, the secondary stage is configured as a full-bridge rectifier to provide a unipolar power supply for the electronic device. In some examples, the isolator includes a transformer or an optical isolator.

While multiple embodiments are disclosed, still other embodiments of the present disclosure will become apparent to those skilled in the art from the following detailed description, which shows and describes illustrative embodiments of the present disclosure. Accordingly, the drawings and detailed description are to be regarded as illustrative in nature and not restrictive.

### BRIEF DESCRIPTION OF THE DRAWINGS

The above-mentioned and other features of this disclosure and the manner of obtaining them will become more apparent and the disclosure itself will be better understood by reference to the following description of embodiments of the present disclosure taken in conjunction with the accompanying drawings, wherein:

FIG. 1 is a block diagram of a flexible power-switch power supply as disclosed herein in accordance with embodiments of the present disclosure.

FIGS. 2A, 2B, and 2C are schematic diagrams of a primary stage in different configurations as disclosed herein in accordance with embodiments of the present disclosure.

FIGS. 3A and 3B are schematic diagrams of an isolator as disclosed herein in accordance with embodiments of the present disclosure.

FIGS. 4A, 4B, and 4C are schematic diagrams of a secondary stage in different configurations as disclosed herein in accordance with embodiments of the present disclosure.

FIGS. 5A and 5B are schematic diagram of a flexible power-switch power supply system in different configurations of a unipolar power supply mode as disclosed herein in accordance with embodiments of the present disclosure.

FIGS. 6A and 6B are schematic diagrams of a flexible power-switch power supply system in different configurations of a bipolar power supply mode as disclosed herein in accordance with embodiments of the present disclosure.

FIG. 7 is a schematic diagram of a flexible power-switch power supply system with two secondary stages as disclosed herein in accordance with embodiments of the present disclosure.

FIG. 8 is a flowchart representing a selection process for rectifier(s) in the secondary stage(s) in accordance with embodiments of the present disclosure.

FIG. 9 is a schematic diagram of a subcomponent of an inverter using the flexible power supply as disclosed herein in accordance with embodiments of the present disclosure.

FIG. 10 is a schematic diagram of a vehicle including a motor operated using the inverter with the flexible power supplies implemented therein, as disclosed herein in accordance with embodiments of the present disclosure.

While the present disclosure is amenable to various modifications and alternative forms, specific embodiments have been shown by way of example in the drawings and are described in detail below. The intention, however, is not to limit the present disclosure to the particular embodiments described. On the contrary, the present disclosure is intended to cover all modifications, equivalents, and alternatives falling within the scope of the present disclosure as defined by the appended claims.

### DETAILED DESCRIPTION OF THE DISCLOSURE

In the following detailed description, reference is made to the accompanying drawings which form a part hereof, and in which is shown by way of illustration specific embodiments in which the present disclosure is practiced. These embodiments are described in sufficient detail to enable those skilled in the art to practice the present disclosure, and it is to be understood that other embodiments can be utilized and that structural changes can be made without departing from the scope of the present disclosure. Therefore, the following detailed description is not to be taken in a limiting sense, and the scope of the present disclosure is defined by the appended claims and their equivalents.

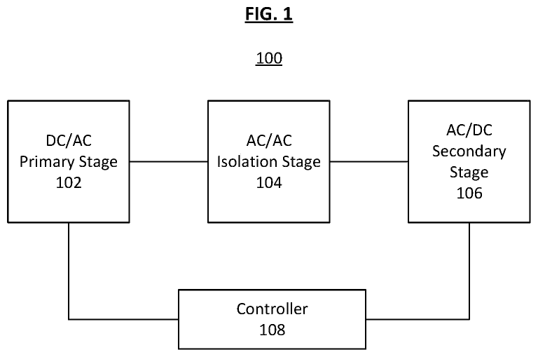

FIG. 1 shows a schematic diagram of a flexible power-switch power supply system 100 which includes a primary stage 102 which converts voltage from direct current (DC) to alternating current (AC), an isolation stage 104 (also referred to as an “isolator”) which provides isolation and adjusts the AC voltage, and a secondary stage 106 which converts the voltage from AC to DC. The primary stage 102 and the secondary stage 106 are both electrically coupled with and controlled by a controller 108 such that the controller 108 controls the operation of the primary stage with or without the feedback from the secondary stage. The outputs of the secondary stage 106 may be connected to a power switch, such as IGBT and/or MOSFET, as known in the art. In some examples, the controller 108 may be a microprocessor or any suitable processing unit or device to control one or more circuits of the primary stage 102. In some examples, the outputs of the secondary stage 106 are coupled with the controller 108 to provide feedback into the controller 108.

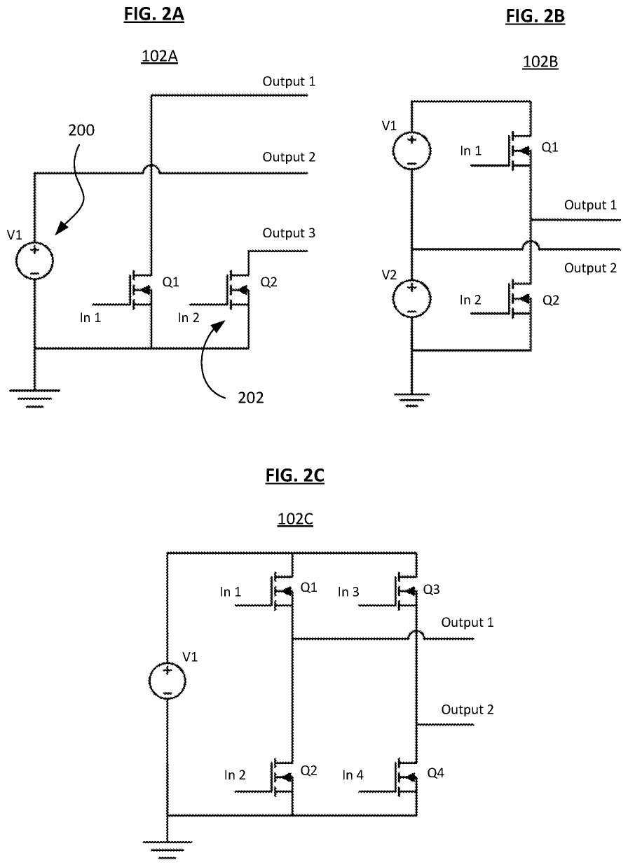

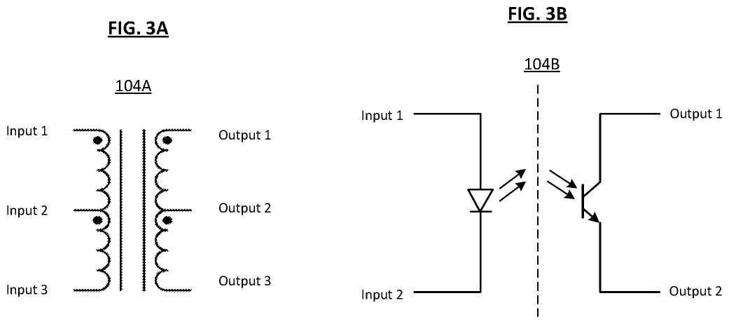

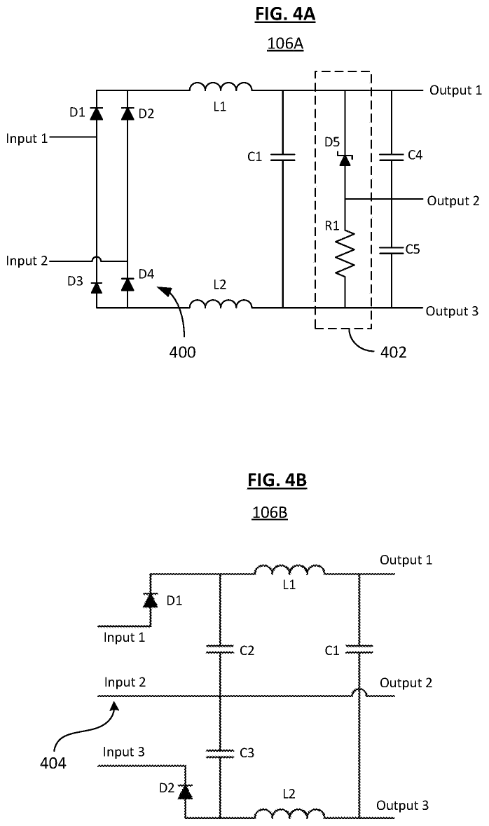

FIGS. 2A, 2B, and 2C show a number of different configurations which may be implemented in the primary stage 102. In each configuration, there is a voltage source 200 and switches 202. In a first configuration 102A, a voltage source V1 (for example, a DC voltage source such as a battery) is provided as well as two switches Q1 and Q2 each of which is activatable in response to an input (e.g., “In 1” and “In 2”, respectively) from the controller 108. The controller 108 input may be in the form of a pulsating DC power supply, with a minimum voltage of 0 volt and any positive maximum voltage as suitable. The switches 202 may be bipolar junction transistor (BJT) and/or MOSFET, for example, as suitable. The first configuration 102A has three outputs (“Output 1”, “Output 2”, and “Output 3”). The first configuration 102A may be implemented in a push-pull inverter circuit.

A second configuration 102B includes two voltage sources V1 and V2, and has two outputs. The second configuration 102B may be implemented in a half-bridge inverter circuit. In a third configuration 102C, there are four switches Q1, Q2, Q3, and Q4 having four inputs and two outputs. The third configuration 102C may be implemented in a full-bridge inverter circuit. The configuration of the primary stage 102 may be selected based on whether the power-switch power supply 100 is to implement a push-pull inverter circuit, a half-bridge inverter circuit, or a full-bridge inverter circuit, for example, as suitable.

FIGS. 3A and 3B show examples of the isolation stage 104, whose purpose is to provide galvanic isolation and a change in the voltage level from the inputs to the outputs thereof. For example, the isolation stage 104 may be a transformer 104A or an optical isolator 104B, as suitable. The number of inputs and outputs may vary according to the number of outputs of the primary stage 102 and the number of inputs of the secondary stage 106, as further explained herein. If the isolation stage 104 is the transformer 104A, the Output 2 may be a tap, which is an access point located along a winding of the transformer which determines the turns ratio. The tap is used to adjust the turns ratio which determines the output voltages in Output 1 and Output 3 with respect to Output 2 of the isolation stage 104. If the isolation stage 104 is the optical isolator 104B (also referred to as opto-isolator, optocoupler, or photocoupler), it may include, for example, a light-emitting diode (LED) and a phototransistor, or any other suitable components for source-sensor combinations, such as LED-photodiode, LED-thyristor (the thyristor may be a light-activated silicon-controlled rectifier or a light-triggered thyristor), and lamp-photoresistor pairs, to name a few.

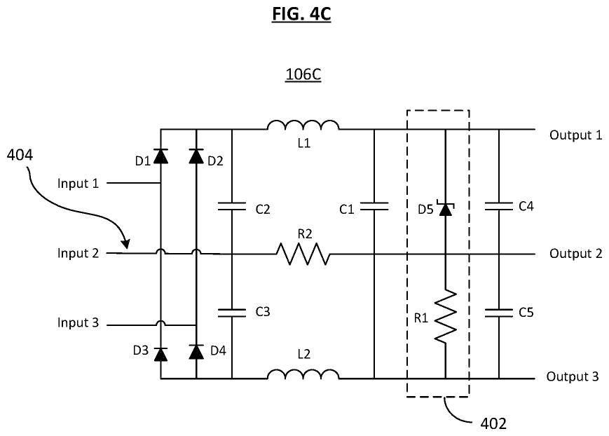

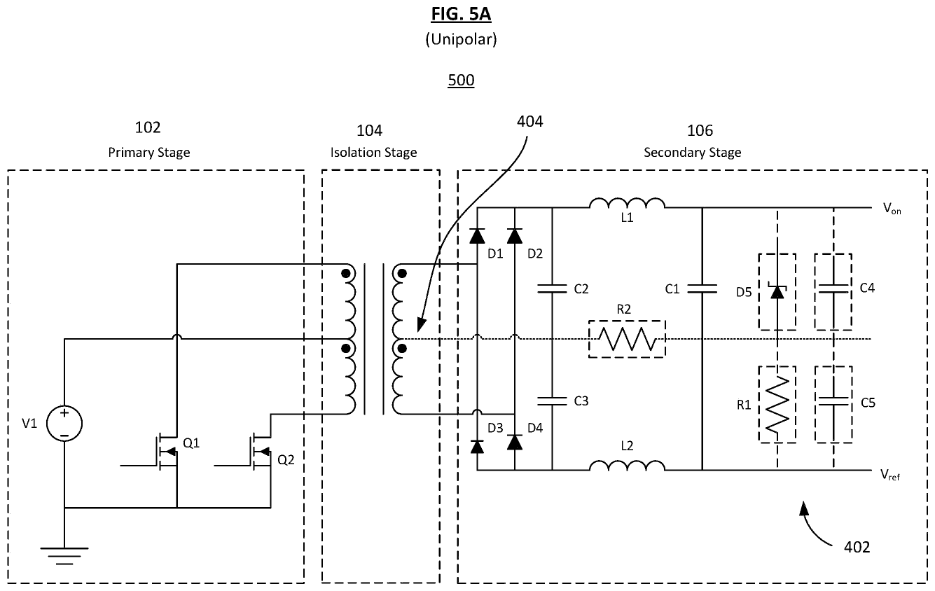

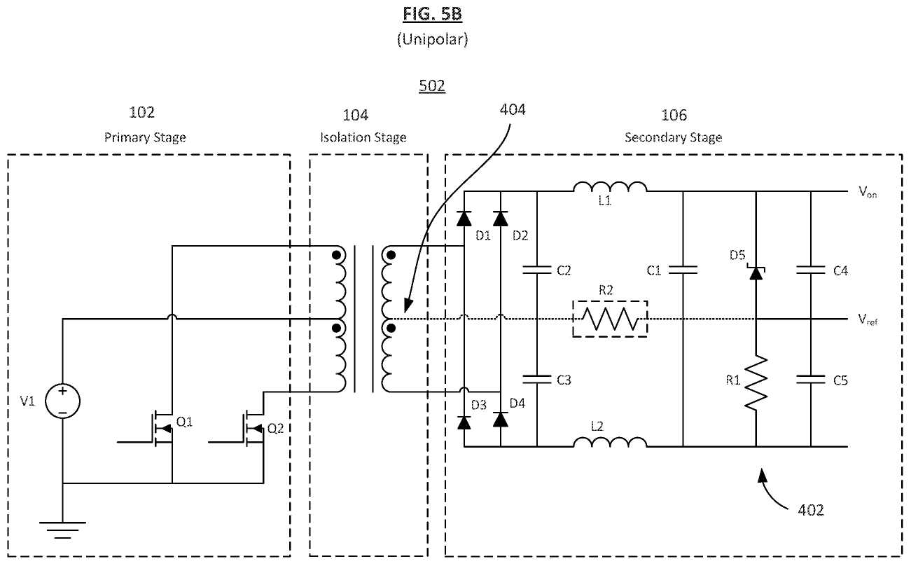

FIGS. 4A, 4B, and 4C show a number of different configurations which may be implemented in the secondary stage 106. In some examples, the secondary stage 106 implements different numbers of diodes 400 as well as a voltage divider 402, as explained herein. A first configuration 106A implements a full-bridge (or full-wave) rectifier circuit using four (4) diodes, D1 through D4. A capacitor C1 may be used as a smoothing capacitor to convert the rippled output of the full-bridge rectifier into a smooth DC output voltage. Similarly, inductors L1 and L2 may be used to allow the DC voltage to pass but restricting the flow of AC voltage to the output, smoothening the output voltage. This embodiment 106A further implements the voltage divider which includes a Zener diode D5 and a resistor R1. The reverse breakdown voltage of the Zener diode D5 is less than the voltage between Output 1 and Output 3. Therefore, the Zener diode D5 is always in the breakdown mode to ensure the voltage between Output 1 and Output 2 equals the reverse breakdown voltage. The voltage between Output 1 and Output 2 can be adjusted by using Zener diodes with different reverse breakdown voltages. Two (2) additional capacitors C4 and C5 may be included to assist the smoothening of the output voltage, similar to C1. Because the turn-on voltage is determined by the breakdown voltage of the Zener diode, the controller in such examples may only be capable of controlling the turn-off voltage.

A second configuration 106B implements a half-bridge rectifier circuit using two (2) diodes D1 and D2, with capacitors C2 and C3 included to convert the pulsating DC voltage to stable DC voltage. The second configuration 106B further includes a tap 404 to control the number of turns in the transformer 104A such that the different turns ratios of the transformer 104A as determined by the tap 404 achieves different outputs for voltage control purposes.

A third embodiment 106C has all components of the first and second embodiments (106A and 106B). In some examples, any one or more of the circuit components shown in the third embodiment 106C may be depopulated or disconnected from the rest of the embodiment 106C. Disconnecting one or more components may be achieved by not having the components soldered on a circuit board, such as a printed circuit board (PCB). The components may be disconnected from the circuit by being unsoldered from the circuit, but the components may still remain attached to the circuit board.

For example, the circuit board may be manufactured such that the diodes, the components of the voltage divider, and/or the tap for the isolator are initially electrically isolated from the remaining circuit, such that the user may control which of the diodes, voltage divider, and/or the tap may be electrically coupled with the remaining circuit by soldering the appropriate components to one or more of the electrical traces also printed on the circuit board. Other components, such as the inductors and some of the capacitors, may be preinstalled to be electrically coupled with the appropriate voltage outputs. The circuit board may also be reusable by removing and reconnecting certain components, as deemed suitable for the next configuration to be utilized, because the circuit board is configured to adapt to more than one configuration (having different features, such as unipolar, bipolar, half-bridge, full-bridge, with voltage divider, without voltage divider, with tap, without tap, etc., as disclosed herein) without having to take apart and reassemble the circuit to accommodate a different configuration. Furthermore, the controller 108 may, in some examples, provide a possibility to sense the output voltage and change the duty cycle of the primary stage 102 accordingly, in a form of a feedback control.

FIGS. 5A and 5B illustrate a first configuration 500 and a second configuration 502 as achieved by the primary stage 102, isolation stage 104, and secondary stage 106 of the power-switch power supply 100, according to some embodiments, when the power supply is a unipolar power supply, in which case the turn-on voltage is positive and the turn-off voltage is zero (0) Volt, and the controller can change the turn-on voltage by controlling the switches on the primary stage 102. In some examples, the controller can be used to regulate the gate voltage to different values.

In the first configuration 500, the voltage divider 402 and the tap 404 are depopulated or disconnected, such that the output voltage is not regulated. In the second configuration 502, the tap 404 is eliminated from the circuit but the voltage divider 402 is intact to clamp the output voltage by the reverse breakdown voltage of the Zener diode D5. It is to be understood that, when the power supply is unipolar, the tap 404 is disconnected by depopulating a resistor R2 (which may be a 0-Ohm resister or jumper in some examples) and the secondary stage 106 forms a full-bridge rectifier.

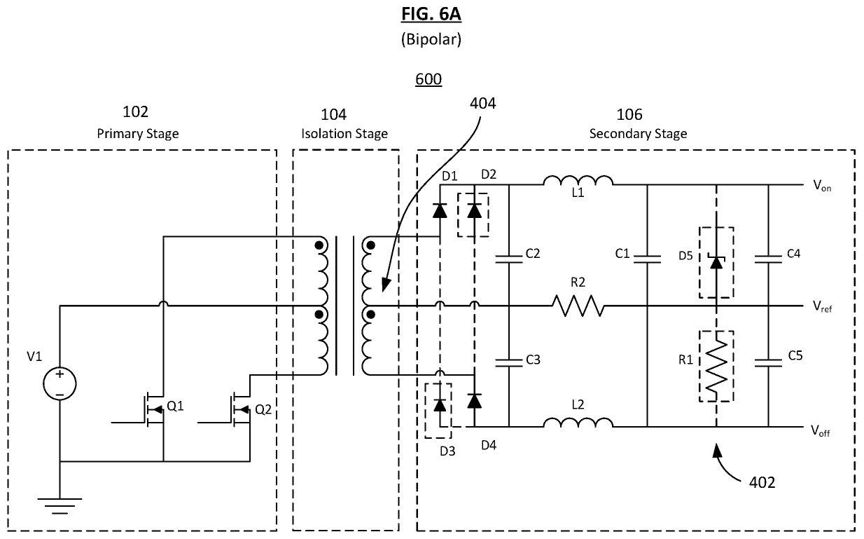

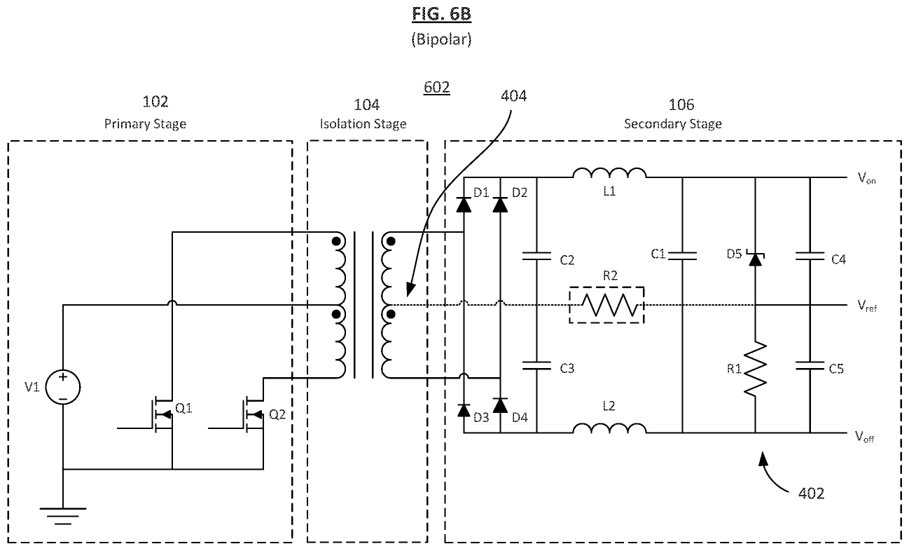

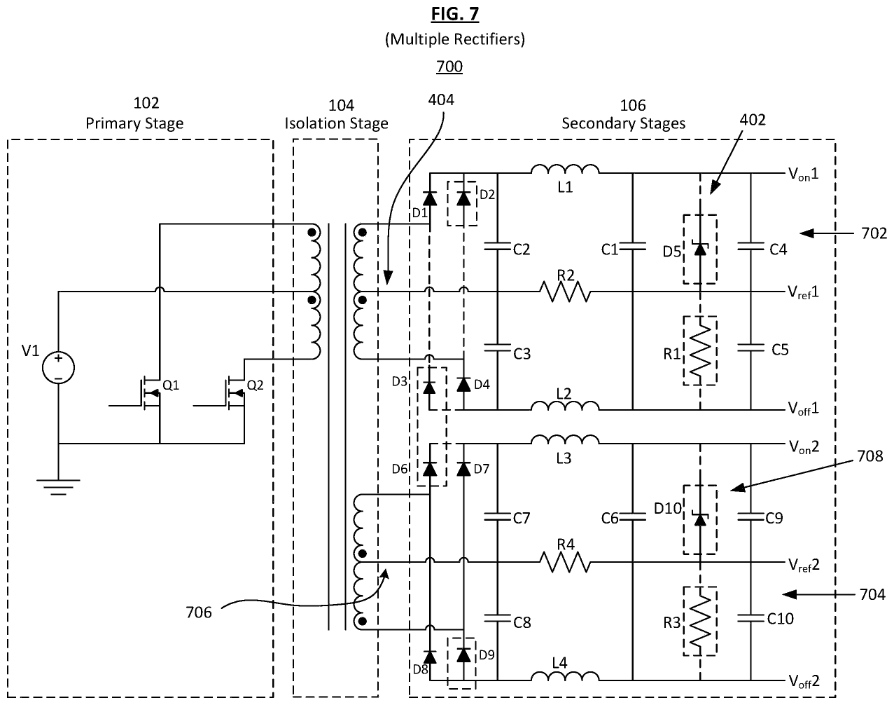

FIGS. 6A and 6B illustrate a first configuration 600 and a second configuration 602 as achieved by the primary stage 102, isolation stage 104, and secondary stage 106 of the power-switch power supply 100, according to some embodiments, when the power supply is a bipolar power supply, in which case the turn-on voltage is positive and the turn-off voltage is negative. Therefore, for the power switch to turn on, the voltage difference between two of the three outputs (Vₒₙ minus V_{ref}) is to be a positive value above a first threshold voltage, and for the power switch to turn off, the voltage difference between two of the three outputs (V_{off} minus V_{ref}) is to be a negative value below a second threshold voltage.

In the first configuration 600, the voltage divider 402 as well as two diodes D2 and D3 are depopulated or disconnected, forming a half-bridge rectifier with a tap 404 from the transformer 104A defining the voltage output at V_{ref}. The voltage is changed by changing the isolator voltage ratio (the primary-to-secondary turns ratio and the location of the tap 404, for example). The first configuration 600 has fewer components, therefore lower loss from power dissipation in the rectifier elements, when compared with the second configuration 602, explained below.

In the second configuration 602, the voltage divider 402 is included, and so are the diodes D2 and D3, but the resistor R2 is depopulated or disconnected such that the tap 404 is eliminated from the circuit. The voltage is changed by changing the isolator voltage ratio and parameters of the voltage divider 402. As such, the second configuration 602 forms a full-bridge rectifier for a power capability higher than the half-bridge rectifier can achieve in the first configuration 600, with the voltage divider 402 controlling the output voltage to achieve better voltage regulation than in the first configuration 600. It is to be understood that configurations 502 and 602 both utilize a full-bridge rectifier (implementing D1, D2, D3, and D4) and a voltage divider 402, without using the tap 404 in the isolator 104.

In some examples, a controller (for example the controller 108 of FIG. 1) may regulate gate voltages to achieve the designed value based on the feedback provided from the secondary stage 106, or more specifically the output DC voltage value of the secondary stage 106. In one example, referring to FIG. 5A, the switches Q1 and Q2 are turned on for a portion of time (a turn-on duration) in every switching period to provide energy to the secondary stage. When the controller senses, e.g. using a voltage sensor, that the output voltage is less than the designed value, the controller may increase the turn-on duration of the switches Q1 and Q2 to provide more energy to the secondary stage to increase the output voltage. Similarly, when the controller senses that the output voltage is more than the designed value, the controller may decrease the turn-on duration of the switches Q1 and Q2 to decrease the output voltage. In some examples, the designed value as mentioned is predetermined or set by a manufacturer of the power supply system 100, or alternatively determined or selected by a user of the power supply system 100. In another example, referring to FIG. 6A, the ratio between turn-on and turn-off voltages may be determined by the turns ratio of two coils on the transformer. The controller can regulate the amplitude of both turn-on and turn-off voltages proportionally by regulating the turn-on time of the switches Q1 and Q2. In another example, referring to FIG. 6B, the turn-on voltage may be determined by the Zener diode D5, and the controller can regulate the turn off voltage by regulating the turn on time of the switches Q1 and Q2.

FIG. 7 illustrates a multiple-second-stage configuration 700 where the secondary stage 106 includes more than one rectifier (in the example shown, two rectifiers 702 and 704) to drive multiple separate switches. In the example shown, each rectifier 702 or 704 may be a half-bridge rectifier with voltage divider 402 and/or 708 depopulated or disconnected from the circuit. The taps 404 and 706 determine the output voltages V_{ref} in the rectifiers. Specifically, that the tap 404 determines output voltage V_{ref}1 and the tap 706 determines output voltage V_{ref}2 as shown in the figure, where both output voltages may be the same or different; furthermore, Vₒₙ1 and V_{off} 1 may be the same as or different from Vₒₙ2 and V_{off}2, respectively. The first rectifier 702 is similar to the rectifier in the first configuration 600 of a bipolar power supply. The second rectifier 704 includes: additional diodes D6 through D9 to form a half-bridge or full-bridge rectifier depending on which diodes are depopulated or disconnected, the second voltage divider 708 that includes a Zener diode D10 and a resistor R3, inductors L3 and L4, a resistor R4 connected with the second tap 706, and capacitors C6 through C10.

Other configurations, such as those with full-bridge rectifiers, without the voltage dividers, and/or with the taps removed from the circuit, as previously disclosed, may be implemented in the rectifiers 702 or 704. Furthermore, although the aforementioned figures indicate the components to be implemented in each configuration, there may be additional circuit components such as resistors, capacitors, and/or inductors, for example, installed on various parts of the circuits to adjust the voltage, current, smoothness of output, etc., of the power-switch voltage supplies, as suitable. The resistance, capacitance, and/or inductance of these components may be adjusted, as needed.

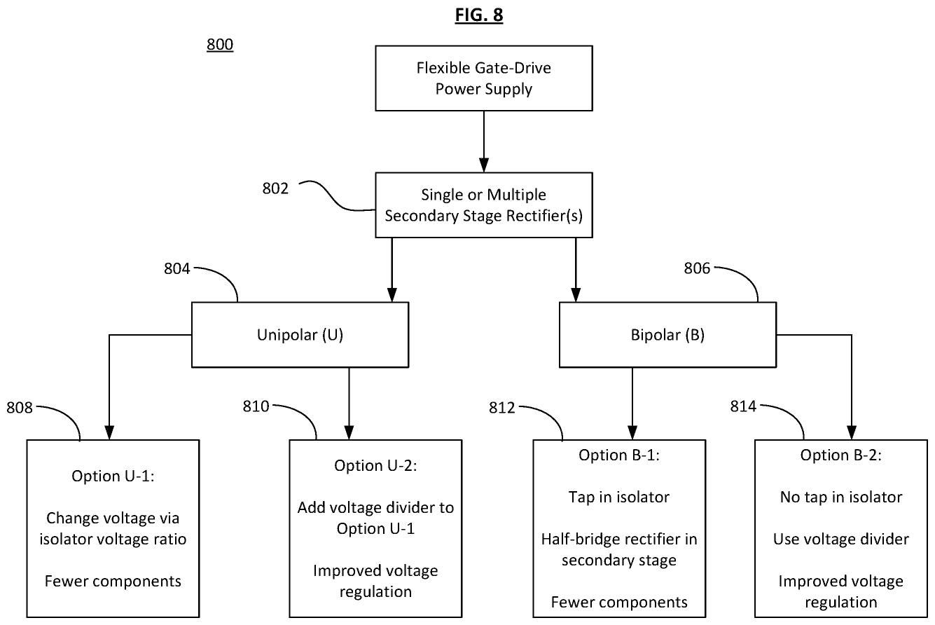

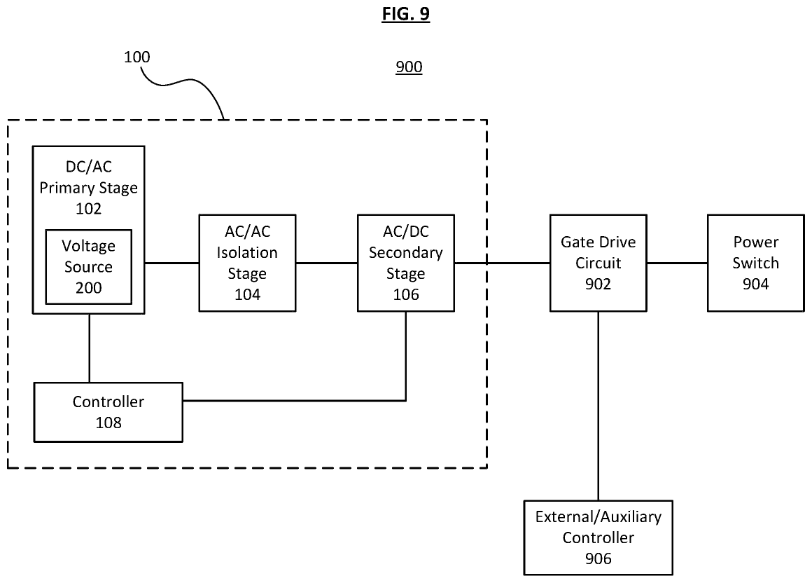

The flowchart in FIG. 8 illustrates a possible selection process 800 of a configuration of power supply to be implemented from the aforementioned various types of configurations. The flowchart begins with a flexible gate-drive power supply, and proceeds to select whether the configuration includes a single secondary stage rectifier or multiple secondary stage rectifiers; 802. The selection 802 may depend on whether the implementation is to provide gate-drive power supply to one or multiple power switches. The secondary stage selection is then performed to determine whether the secondary stage is to be unipolar 804 or bipolar 806. If unipolar, there are two options: U-1 (808) and U-2 (810), where option U-1 can change the voltage via isolator voltage ratio without the use of a voltage divider to achieve fewer components, and option U-2 includes the voltage divider for improved voltage regulation. Alternatively, if bipolar, there are two options: B-1 (812) and B-2 (814), where option B-1 includes a tap in the isolator and uses a half-bridge rectifier in the secondary stage to achieve fewer components, and option B-2 has no tap in the isolator and instead uses a full-bridge rectifier as well as a voltage divider for improved voltage regulation. Option U-1 is represented by the configuration 500, option U-2 by the configuration 502, option B-1 by the configuration 600, and option B-2 by the configuration 602, assuming that only one rectifier is present as the secondary stage. For multiple rectifiers, any combination of the aforementioned options may be implemented.

It is to be understood that the configurations 500, 502, 600, 602, and/or 700 may be implemented on the same printed circuit board with a plurality of common circuit elements. For example, in view of FIGS. 5 through 7, the components D1, D4, C1, C2, C3, L1, and L2 are all common to the configurations disclosed. As such, these components may be soldered on to the circuit board, whereas the other components, such as D2, D3, D5, C4, C5, R1, and R2, for example, may be attached but initially disconnected from the circuit. The user may determine which one of the aforementioned configurations to implement and solder one or more of the other components to electrically couple these components with the aforementioned common components to enable the desired configuration. Regarding the configuration 700, all of the components that constitute the additional rectifier 704 may be soldered onto the printed circuit board as an option, without requiring the first rectifier 702 to be removed or recircuited to accommodate for the added rectifier 704.

As presently disclosed, the embodiments of gate-drive power supply in this application are flexible in that they can be adjusted to cater to different voltage requirements as well as unipolar-or-bipolar requirement for different power switches by depopulating or disconnecting components or adjusting component parameters. The embodiments comprise a primary stage, an isolation stage, at least one secondary stage, and a controller. The primary stage converts DC voltage from a DC power source to AC voltage applying on the isolation stage (e.g., a transformer, an optical isolator) primary side, the circuit topology of the primary stage being push-pull, full-bridge, half-bridge, or other circuits. The isolation stage, or isolator, transfers energy from the input to at least one output. The isolator provides galvanic isolation and changes the voltage level as desired. Each output from the isolator connects to a secondary stage which converts AC voltage to one or two DC voltage(s). The circuit topology for the secondary stage can be full-bridge rectifier, half-bridge rectifier, or other circuits as known in the art.

To generate a unipolar power supply, the isolator's output does not require a tap and the voltage divider (e.g., a Zener diode in series with a resistor) in the secondary stage may be removed or disconnected. Without the voltage divider, the output voltage can be adjusted by the isolator voltage ratio. When the voltage divider is used, the output voltage is regulated via the voltage divider. The isolator voltage ratio may be selected to facilitate reduced loss in the voltage divider.

To generate bipolar power supply, there are two options. The first option is to use a tap in the isolator output and use half-bridge rectifier topology for the secondary stage. The tap divides the secondary-side output into two sections. Taking the voltage potential of the tap as a reference voltage, positive and negative voltages are generated based on the reference voltage. The voltage levels can be adjusted by the isolator voltage ratios of the isolator input and each of the two sections of the isolator output. This first option has low loss due to having fewer number of circuit components which may dissipate power.

The second option removes the tap of the isolator output from use in the circuit. Instead, a voltage divider is used to divide the output voltage into two sections to generate positive and negative voltages. The voltage difference between the positive and negative voltages can be adjusted by the isolator voltage ratio. How this voltage difference is divided into positive and negative voltages can be adjusted by the voltage divider parameter. The second option has improved voltage regulation performance. Furthermore, the isolator can have multiple outputs connected to multiple secondary stages to supply gate voltages of multiple power switches.

Therefore, the flexibility of the power supply is due to the capability of both unipolar and bipolar power supply. The unipolar power supply has two options (with or without the voltage divider) and the bipolar power supply also has two options (using a tap but no voltage divider for a half-bridge rectifier, or using a voltage divider but no tap for a full-bridge rectifier). Also, the voltage levels can be adjusted by changing the isolator voltage ratio and/or voltage divider parameters (such as the reverse breakdown voltage for the Zener diode).

The configuration 500 or 502 may be implemented to form a unipolar power supply with different output voltages. In some examples, the parameters of the circuit components are adjusted such that an output voltage of at least 15 volts is achieved. As previously explained, some Si-based IGBTs may have turn-on/off voltages of +15/0 volts. This circuit can be used to drive IGBTs, although the gate voltage can change based on the load, therefore the gate voltage may not always be the optimum. In some examples, a lower output voltage of at least 10 volts may be achieved, in which case the circuit can be used to drive Si-based MOSFETs which may have turn-on/off voltages of +10/0 volts. Alternatively, in some examples, a higher output voltage of at least 18 volts may be achieved, in which case the circuit can be used to drive SiC-based MOSFETs which may have turn-on/off voltages of +18/0 volts. Furthermore, in some examples, the output voltage at no load may be up to 10%, 15%, 20%, or 25% higher than the output voltage at full load when the voltage divider is disconnected from the circuit.

The configuration 600 or 602 may be implemented to form a bipolar power supply with different output voltages. In some examples, the parameters of the circuit components are adjusted such that the positive output voltage (for example, the voltage output at Output 1) is at least +15 volts while the negative output voltage (for example, the voltage output at Output 3) is at or lower than −8 volts in which case the circuit can be used to drive Si-based IGBTs which may have turn-on/off voltages of +15/−8 volts. In some examples, the positive output voltage is at least +18 volts while the negative output voltage may be at or less than −2 volts in which case the circuit can be used to drive SiC-based MOSFETs which may have turn-on/off voltages of +18/−2 volts. In some examples, the use of a voltage divider in the circuit enables a smaller difference in voltage output values between when the circuit is at no load and when the circuit is at full load, thereby achieving a more stable voltage output, than when the voltage divider is removed or disconnected. Note that the values described herein may be changed by changing the parameters and/or positions of certain components.

Advantages of implementing the power supply system 100 as disclosed herein include the flexibility to accommodate various different turn-on and turn-off voltage value requirements for applications including, but not limited to, traction drive, battery/fuel cell-based stationary power supply, and/or fast charging (e.g., for electric vehicles). The primary and secondary stages may be adjustable or modular (e.g., changeable and/or replaceable) to facilitate the flexible adjustment, based on the turn-on and turn-off voltage value requirements. The system may also be used for both Si-based switches as well as wide-bandgap switches. The system can also be adjusted to provide different unipolar or bipolar gate voltages to cater to different power switches by depopulating components or adjusting component parameters, as disclosed herein.

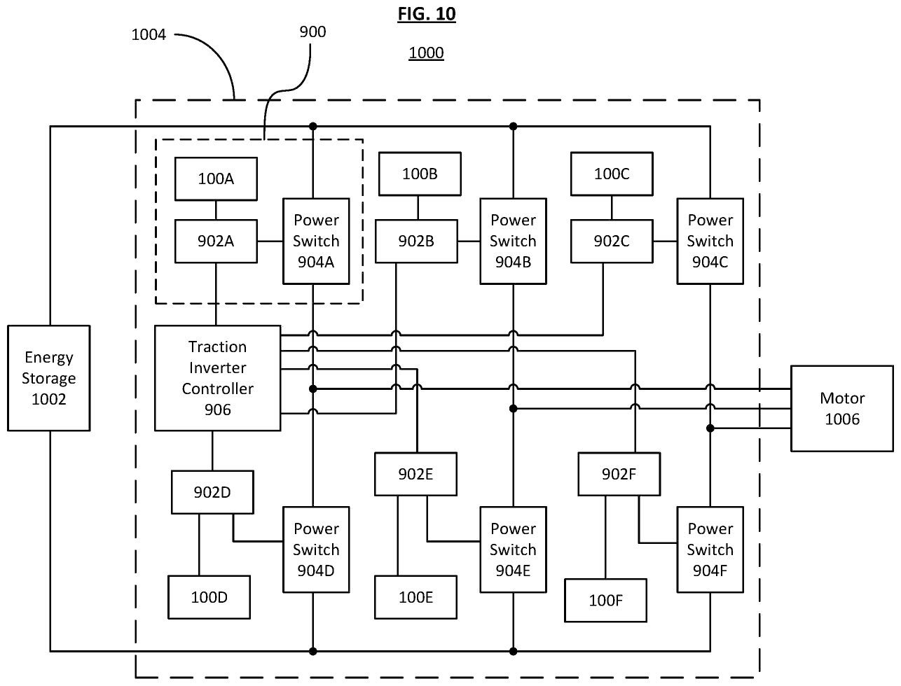

FIG. 9 illustrates an example of an inverter subcomponent 900 implementing the power supply system 100. The voltage source 200 implemented in the power supply system 100 may be a low-voltage power source, for example. The outputs of the secondary stage 106 are connected to a gate drive circuit 902 which in turn is connected to a power switch 904, including but not limited to IGBT and/or MOSFET, as known in the art, which may be used in any suitable automobile application including but not limited to the traction inverter of the vehicle, for example. The gate drive circuit 902 is controlled via an external or auxiliary controller 906 such as a traction inverter controller, as further explained herein. Because the gate drive circuit dissipates energy during the switching process, the power supply system 100 as disclosed herein is capable of providing stable voltage values to activate the switch.

FIG. 10 illustrates an example of a vehicle 1000 which includes a plurality of the inverter subcomponents 900. The vehicle 1000 includes an energy storage 1002 capable of providing the electrical power necessary to operate the vehicle 1000, an inverter 1004 to convert the DC power from the energy storage 1002 into AC power, and a motor 1006 which receives the AC power from the inverter 1004 to operate. The inverter 1004 includes a plurality of inverter subcomponents 900, where all the subcomponents 900 are coupled with the traction inverter controller 906 such that the traction inverter controller 906 provides the control signals to each of the subcomponents 900 in operating the inverter 1004.

The illustrated example shows six (6) inverter subcomponents 900, although only one is indicated as such. The inverter 1004 is a three-phase inverter, although any other type of inverter may be used as well. It is to be understood that any suitable number of subcomponents may be implemented, as suitable for the inverter design, for example six-phase inverters. Each subcomponent 900 of the inverter 1004 includes the flexible power-switch power supply system 100 (labelled A through F), the gate drive circuit 902 (labelled A through F), and the power switch 904 (labelled A through F). The power switches 904 are operated to open or close so as to control the voltage applied on each leg of the inverter 1004 to provide AC power for the motor 1006, as known in the art.

It is to be understood that the above description is intended to be illustrative, and not restrictive. Many other embodiments will be apparent to those of skill in the art upon reading and understanding the above description. For example, it is contemplated that features described in association with one embodiment are optionally employed in addition or as an alternative to features described in associate with another embodiment. The scope of the present disclosure should, therefore, be determined with reference to the appended claims, along with the full scope of equivalents to which such claims are entitled.

What is claimed is:

1. A flexible power switch gate-drive power supply comprising:
a primary stage comprising an inverter and a voltage source;
an isolator electrically coupled with outputs of the primary stage and configured to change voltage level;
a secondary stage comprising a rectifier and electrically coupled with outputs of the isolator; and
a controller electrically coupled with the primary stage and the secondary stage.

2. The flexible power supply of claim 1, wherein the secondary stage is configured as a full-bridge rectifier to provide a unipolar power supply.

3. The flexible power supply of claim 2, wherein the secondary stage includes a voltage divider comprising a Zener diode in series with a resistor.

4. The flexible power supply of claim 1, wherein the isolator is a transformer comprising a tap.

5. The flexible power supply of claim 4, wherein the secondary stage is configured as a half-bridge rectifier and electrically coupled to the tap with one of the outputs of the secondary stage to provide a bipolar power supply.

6. The flexible power supply of claim 4, wherein the secondary stage is configured as a full-bridge rectifier and a voltage divider is connected to provide a bipolar power supply, the voltage divider comprising a Zener diode in series with a resistor.

7. The flexible power supply of claim 1, comprising a plurality of secondary stages, wherein each rectifier is independently configured to provide both a unipolar power supply and a bipolar power supply.

8. The flexible power supply of claim 1, wherein the primary stage comprises a push-pull inverter, a half-bridge inverter, or a full-bridge inverter.

9. The flexible power supply of claim 1, wherein the isolator comprises a transformer or an optical isolator.

10. The flexible power supply of claim 9, wherein a ratio of a turn-on voltage of the flexible power supply to a turn-off voltage of the flexible power supply is determined based on a turns ratio of two coils on the transformer.

11. The flexible power supply of claim 1, wherein the secondary stage comprises a half-bridge rectifier or a full-bridge rectifier.

12. The flexible power supply of claim 1, wherein the controller is configured to regulate gate voltage of the flexible power supply based on a sensed output voltage value of the secondary stage.

13. The flexible power supply of claim 12, wherein the gate voltage is regulated by increasing or decreasing, by the controller, a turn-on duration of switches in the inverter of the primary stage.

14. The flexible power supply of claim 1, wherein at least one of the primary stage or the secondary stage is modular or changeable.

15. A vehicle comprising:
a motor;
an energy storage configured to provide electrical power to the motor; and
an inverter coupled with the motor and the energy storage, the inverter comprising:
a) a plurality of flexible power switch gate-drive power supplies, each flexible power switch gate-drive power supply comprising:
a primary stage comprising an inverter and a low-voltage power source,
an isolator electrically coupled with outputs of the primary stage and configured to change voltage level,
a secondary stage comprising a rectifier and electrically coupled with outputs of the isolator, and
a controller electrically coupled with the primary stage and the secondary stage;
b) a plurality of gate drive circuits each operatively coupled with one of the plurality of flexible power switch gate-drive power supplies; and
c) a plurality of power switches each operatively coupled with one of the plurality of gate drive circuits and configured to operate the inverter.

16. The vehicle of claim 15, wherein at least one of the primary stage or the secondary stage is modular or changeable according to turn-on and turn-off voltage value requirements of the power switch.

17. The vehicle of claim 15, wherein the primary stage comprises a push-pull inverter, a half-bridge inverter, or a full-bridge inverter.

18. The vehicle of claim 15, wherein the isolator is a transformer comprising a tap, and the secondary stage is configured as a half-bridge rectifier and electrically coupled to the tap with one of the outputs of the secondary stage to provide a bipolar power supply for the electronic device.

19. The vehicle of claim 15, wherein the secondary stage is configured as a full-bridge rectifier to provide a unipolar power supply for the electronic device.

20. The vehicle of claim 15, wherein the isolator comprises a transformer or an optical isolator.
